(19) United States
(12) Patent Application Publication
(10) Pub. No.: US 2026/0336163 A1
(43) Pub. Date: Oct. 29, 2026

(54) METHOD FOR PRODUCING A CONCRETE SLAB FROM PRESTRESSED CONCRETE

(71) Applicant: HOLCIM TECHNOLOGY LTD, ZUG (CH)

(72) Inventors: Maximilian Leo Josef REINKE, HOLDERBANK (CH); Jörg SWITALA, HOLDERBANK (CH)

(21) Appl. No.: 19/117,856

(22) PCT Filed: Oct. 3, 2023
(86) PCT No.: PCT/IB2023/059895

§ 371 Date: Apr. 2, 2025

(30) Foreign Application Priority Data
Oct. 4, 2022 (EP) 22020480.4

(51) Int. Cl. B28B 23/04; B28B 23/00; E04C 2/06

(52) U.S. Cl. CPC B28B 23/04; B28B 23/0006; E04C 2/06

(57) ABSTRACT

A method for producing a concrete slab made of prestressed concrete, whose tensioning members include a plurality of rovings, particularly carbon fiber rovings, extending through the concrete slab parallel to the slab plane, includes producing a formwork that is bounded at the bottom by a manufacturing table and whose side walls are penetrated by prestressed rovings, pouring concrete into the formwork and allowing the concrete to set, and cutting off laterally protruding areas of the rovings, wherein the side walls of the formwork are produced by piling a powdery construction material that hardens through liquid addition onto the manufacturing table and moistening the pile.

The invention relates to a method for producing a concrete slab made of prestressed concrete, whose tensioning members comprise a plurality of rovings, particularly carbon fiber rovings, extending through the concrete slab parallel to the slab plane, comprising the steps:
producing a formwork that is bounded at the bottom by a manufacturing table and whose side walls are penetrated by prestressed rovings,
pouring concrete into the formwork and allowing the concrete to set, and
cutting off laterally protruding areas of the rovings.

In the production of prestressed concrete, tensioning members, such as tensioning wires or strands, are friction-locked connected to the concrete, so that relative displacement between the two materials practically does not occur. Here, a direct bond between tensioning members and concrete can be established, as is often done in the production of precast concrete elements in precast plants, where tensioned wires or strands are encased in concrete in the precast element. After concreting and hardening of the concrete, the prestressing is released. Through the bond between concrete and tensioning members as well as anchoring of the relaxed tensioning members, the tensioning force is applied to the precast element.

WO 2014/040653 A1 discloses a precast concrete component in which the reinforcement or tensioning members are formed by a plurality of rovings, i.e., bundles, strands, or multifilament yarns of parallel arranged filaments or continuous fibers. The rovings can include carbon or glass fibers.

For the production of such fiber-reinforced concrete components, the rovings must be tensioned in several layers overlapping in longitudinal and transverse direction. This process must be completed before the production of the concrete components begins, and the tensioned rovings must penetrate the formwork for the concrete component. The rovings must be excluded from the formwork or built around. Conventional formwork systems prove disadvantageous here. The multitude of openings for the rovings to be tensioned complicates the use of prefabricated formwork parts. Furthermore, the formwork must be designed to ensure a liquid-tight passage of the rovings to prevent leakage of fresh concrete or other liquids.

Additionally, particularly carbon fiber rovings are extremely fragile, so they can be easily damaged during the creation or assembly of the formwork.

The invention therefore aims to improve the production of concrete slabs from prestressed concrete using rovings with regard to the formwork. In particular, a formwork should be created that can be produced with simple means and in a short time and that allows a liquid-tight passage of the rovings without damaging them. Furthermore, the formwork should not cause unnecessary waste material that requires expensive disposal.

To solve this problem, the invention, in a method of the type mentioned at the outset, essentially consists in that the side walls of the formwork are produced by piling a powdery construction material that hardens through liquid addition onto the manufacturing table and moistening the pile.

By piling a powdery construction material, the rovings are hardly mechanically stressed, preventing damage to them. Due to the powdery state, the construction material can trickle into the spaces between adjacent rovings, enabling complete embedding of the rovings in the resulting pile. If necessary, this process can be supported by a vibrating movement, e.g., vibrating the manufacturing table. The embedding of the rovings in the pile ensures, after stabilization or hardening of the pile, a tight passage of the rovings through the pile or the resulting edge formwork. The pile is formed into a dimensionally stable edge formwork by the fact that the pile consists of a construction material that hardens with the addition of liquid, which is moistened after piling.

Preferably, the construction material contains or consists of a hydraulic binder, particularly cement. This has the positive effect that the edge formwork does not represent foreign material in relation to the concrete and can be easily removed from the edge of the plate after the concrete slab has hardened, such as by breaking or sawing off. The edge formwork can subsequently be crushed and, depending on the composition of the hydraulic binder, reused for the production of new concrete and/or recycling products.

A Portland cement-based cement can be used as cement, such as the cements defined in standard EN 197-1, including Portland cement CEM I, Portland composite cement CEM II, blast furnace cement CEM III, pozzolanic cement CEM IV, and composite cement CEM V. To ensure a short setting time, a setting accelerator may be added to the cement.

Particularly preferred, the hydraulic binder is a rapid-hardening cement, such as a calcium aluminate cement.

A mortar can be used a s a cement-containing construction material.

The construction material is preferably piled onto the prestressed rovings, whereby the pile can have a substantially trapezoidal cross-section.

To achieve automated production of the pile, a preferred embodiment of the inventive method provides that the pile is produced by discharging the construction material from a movable discharge head of a construction material supply or storage device. The discharge head can be moved along the edge of the formwork to be formed while the powdery construction material is applied to the manufacturing table, resulting in a linear pile. The linear pile surrounds the area into which the concrete is subsequently poured for the formation of the concrete slab, so that a circumferential edge formwork can be formed.

The moistening of the pile preferably includes applying, particularly spraying, a liquid, particularly water, onto the pile. Here, the liquid is applied to the surface of the pile, so that the surface area of the pile sets. It is not absolutely necessary for the entire cross-section of the pile to set, as it is sufficient for the stability of the edge formwork if a stable skin forms. This is particularly because after pouring the fresh concrete, the pile draws additional liquid from the concrete, which promotes the further setting and hardening process of the pile.

The application of the powdery construction material by means of the movable discharge head can be done in a single pass. Alternatively, multiple layers of the construction material can be applied on top of and/or next to each other. The moistening of the pile preferably takes place after the application of the last construction material layer. Alternatively, moistening can occur after each construction material layer.

The application of liquid to the pile can take place immediately after piling the construction material, particularly with the help of a liquid discharge device, such as a spray nozzle, that runs synchronously with the movable discharge head. In this context, a preferred embodiment provides that the application is carried out by means of at least one liquid discharge device, particularly a spray nozzle, arranged on the discharge head. The position of the liquid discharge device(s) on the discharge head is basically arbitrary. For example, the spray nozzle can be arranged behind a discharge opening of the discharge head in the direction of movement of the discharge head and directed at the pile discharged by the preceding discharge opening. Preferably, the discharge head comprises a plurality of spray nozzles that have different nozzle axes from each other. In this way, the liquid can be specifically directed at both sloping flanks of the pile and at the upper surface.

The discharge head can further have a scraping element downstream of the discharge opening in the direction of movement, which scrapes off material exceeding a defined height, thereby creating a substantially planar, horizontal upper surface.

It can also be preferably provided that the area of the manufacturing table to be covered by the pile is moistened before applying the pile. This promotes setting of the pile at the lower interface of the pile, which facilitates subsequent removal of the hardened pile from the manufacturing table after the concrete slab has been produced. The moistening of the manufacturing table is preferably carried out by means of a spray nozzle arranged on the discharge head.

After setting and at least partial hardening of the concrete slab, the side walls of the formwork can be removed, e.g., by sawing them off from the concrete slab. The sawing can be done as a trimming cut, which gives the concrete slab the desired dimensions.

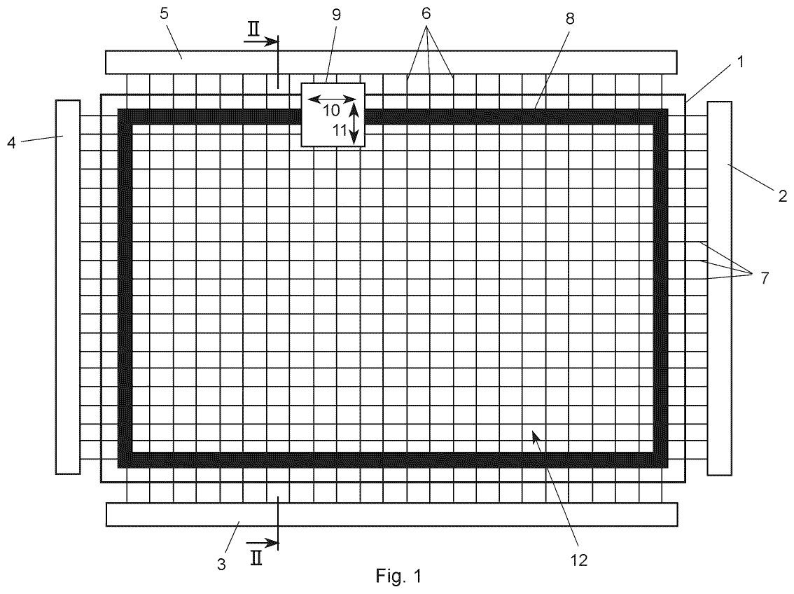

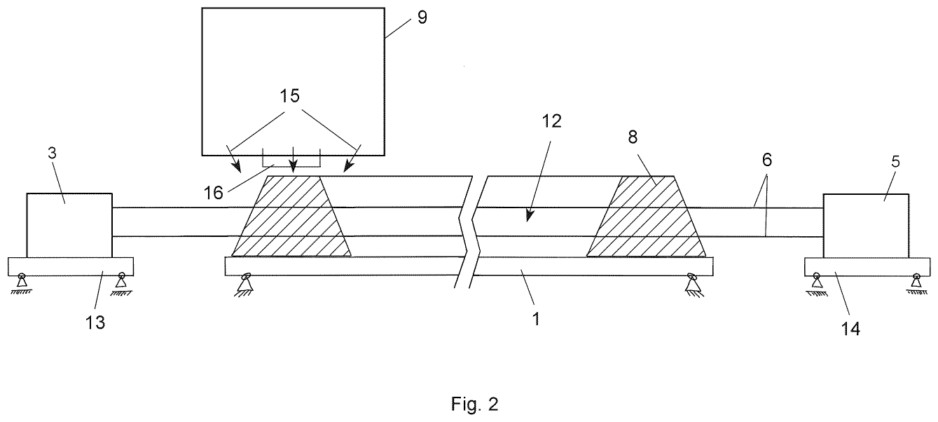

The invention is further explained below with reference to embodiments schematically shown in the drawing. FIG. 1 shows a top view of a manufacturing table for producing concrete slabs, and FIG. 2 shows a section along line II-II of FIG. 1.

FIG. 1 shows a manufacturing or formwork table 1, at the edges of which holding elements 2, 3, 4, and 5 are arranged, with a plurality of carbon rovings 6, 7 tensioned between opposite holding elements 2 and 4 or 3 and 5, whereby one group of carbon rovings 6 crosses another group of carbon rovings 7 and, as can be seen in FIG. 2, at least two layers of carbon rovings are arranged one above the other.

The carbon rovings thus span the manufacturing table 1 in two perpendicular directions.

The formwork table 1 forms the bottom of a formwork into which fresh concrete is poured to produce a concrete slab from prestressed concrete. The side walls of the formwork are formed by a circumferential pile 8 of a powdery construction material that hardens with the addition of liquid, particularly dry cement or cement mortar. The construction material is applied by means of a movable discharge head 9 of a construction material supply or storage device. The discharge head 9 is movable in the sense of the double arrows 10 and 11 and is moved by a drive according to the desired course of the edge formwork. The pile 8 is sprayed with liquid through spray nozzles not shown, so that the pile 8 sets at least on the surface and, after setting, forms a dimensionally stable edge formwork.

After the formation of the edge formwork, liquid concrete is poured into the area 12 bounded by the edge formwork and allowed to set. After hardening of the concrete, the edge formwork is removed, leaving a concrete slab made of prestressed concrete. The concrete slab produced in this way can be trimmed at its edges and/or divided into smaller slab pieces by means of a suitable cutting device, such as a concrete saw. Concrete components of any shape can also be milled from the concrete slab using a concrete milling machine.

In the sectional view according to FIG. 2, it can be seen that the holding elements 3 and 5 are each arranged on a receiving device 13 or 14. It is also recognizable that the pile 8 has a substantially trapezoidal cross-section caused by the piling process. The carbon rovings 6 penetrate the pile 8 and are embedded in it, forming a tight closure of the area 12 bounded by the pile 8 for the liquid concrete.

The discharge head 9 includes a discharge opening 16 and is further equipped with schematically indicated spray nozzles 15 for applying liquid to the pile 8.

1. A method for producing a concrete slab made of prestressed concrete, whose tensioning members comprise a plurality of rovings extending through the concrete slab parallel to the slab plane, comprising:
producing a formwork that is bounded at a bottom by a manufacturing table and whose side walls are penetrated by prestressed rovings,
pouring concrete into the formwork and allowing the concrete to set, and
cutting off laterally protruding areas of the rovings, wherein the side walls of the formwork are produced by piling a powdery construction material that hardens through liquid addition onto the manufacturing table and moistening the pile.

2. The method according to claim 1, wherein the construction material contains or consists of a hydraulic binder.

3. The method according to claim 2, wherein the hydraulic binder is a rapid-hardening cement.

4. The method according to claim 1, wherein the construction material is piled onto the prestressed rovings.

5. The method according to claim 1, wherein the pile has a substantially trapezoidal cross-section.

6. The method according to claim 1, wherein the pile is produced by discharging the construction material from a movable discharge head of a construction material supply or storage device.

7. The method according to claim 1, wherein the moistening of the pile comprises applying a liquid onto the pile.

8. The method according to claim 7, wherein the application is carried out by means of at least one liquid discharge device arranged on the discharge head.

9. The method according to claim 1, wherein the area of the manufacturing table to be covered by the pile is moistened before the pile is applied.

10. The method according to claim 9, wherein the moistening of the manufacturing table is carried out by means of a spray nozzle arranged on the discharge head.

11. The method according to claim 1, wherein the plurality of rovings are carbon fiber rovings.

12. The method according to claim 2, wherein the hydraulic binder is cement.

13. The method according to claim 7, wherein the applying comprises spraying the liquid onto the pile.

14. The method according to claim 7, wherein the liquid is water.

15. The method according to claim 8, wherein the at least one liquid discharge device comprises a spray nozzle.
